(19) United States
(12) Patent Application Publication
(10) Pub. No.: US 2013/0140296 A1
(43) Pub. Date: Jun. 6, 2013

(54) HEATING CARTRIDGE AND THERMOSTATIC ELEMENT COMPRISING SUCH A CARTRIDGE

(71) Applicants: René Mas, Bretigny Sur Orge (FR); Loïc Madoux, Boesses (FR)

(72) Inventors: René Mas, Bretigny Sur Orge (FR); Loïc Madoux, Boesses (FR)

(73) Assignee: VERNET, OLLAINVILLE (FR)

(21) Appl. No.: 13/812,833

(22) PCT Filed: Jul. 26, 2011
(86) PCT No.: PCT/FR2011/051797

§ 371 Date: Feb. 8, 2013

(30) Foreign Application Priority Data
Jul. 29, 2010 (FR) 10 56241

(51) Int. Cl. H05B 3/44

(52) U.S. Cl. CPC H05B 3/44
USPC 219/534; 219/547

(57) ABSTRACT

A heating cartridge includes a tube that is thermally and electrically conductive, a first end portion thereof is to be embedded within a heat-expandable material of a thermostatic element; a rod which is electrically conductive and extends at least partially inside the tube in a substantially coaxial manner; and a heating resistor comprising a tubular body which comprises an electrically resistant material and radially positioned between a first end portion of the rod and the first end portion of the tube, by forming a cylindrical interface for electrical contact between the rod and the inner surface of the tubular body as well as a cylindrical interface for electrical contact between the tube and the outer surface of the tubular body, the tube and the rod including respectively, opposite their first end portion, second end portions which are respectively adapted to be connected to the poles of an external current source.

This invention relates to a heating cartridge for a thermostatic element. It further relates to a thermostatic element comprising such a cartridge.

In many applications in the field of fluids, in particular for the cooling of heat engines of vehicles, thermostatic valves are used to distribute an incoming fluid into various circulation channels, according to the temperature of this fluid. These valves are referred to as thermostatic in that the displacement of their internal shutter or shutters is controlled by a thermostatic element, i.e. an element that comprises a cup containing a heat-expandable material and a piston which can be displaced by sliding in relation to the cup under the action of the heat-expandable material when the latter expands or contracts.

In order to distribute the fluid according to other parameters, in particular conditions outside of the valve such as ambient temperature or the load of the vehicle propelled by the engine provided with the valve, it is known to incorporate into the valve a electric cartridge in order to heat the heat-expandable material, which makes it possible to control the valve from the outside of the latter, independently or in addition to the temperature of the incoming fluid, in particular by means of a suitably-programmed calculator onboard the vehicle. The heating cartridge comprises to this effect a heating resistor, arranged inside the aforementioned piston or an analogous metal tube: by immobilising, for example, the piston to the external case of the valve, the electrical power of the resistor causes a rise in the temperature of the heat-expandable material, which results, through dilatation of the latter, the sliding of the cup around the piston, a shutter being carried by this cup to act on the circulation of the fluid through the valve.

In practice, the aforementioned heating resistor is substantially comprised of a resistant filament in the shape of a spire, which is embedded in a heat-conductive powder, such as a magnesium oxide powder, compacted into the bottom of the tube, and which is connected to two conducting wires rising in the piston or the tube of the thermostatic element, of which the free ends are to be electrically connected to an external current source. An example of such a heating cartridge with thermostatic element is provided by DE-A-3709285.

This heating cartridge design is complex, and therefore expensive, in particular due to the fact that it requires delicate assembly operations, as well as operations for electrically connecting the wires of the resistor, such as operations of welding or crimping. In addition, the filamentary structure of the heating resistor is such that the resistivity of the latter is substantially constant according to the temperature: the electrical power of the heating resistor must be regulated and controlled with precision, in particular in order to prevent it from overheating which would risk damaging the thermostatic element irreversibly.

U.S. Pat. No. 4,697,069 proposes a heating cartridge, not for a thermostatic element, but for a washing machine. This heating cartridge is based on the same technology as that of DE-A-3709285, i.e. the presence of an electrical heating resistor which is constituted of a spire embedded in a magnesium oxide powder. According to certain forms of embodiments considered in U.S. Pat. No. 4,697,069, the aforementioned spire can be supplied electrically either by an inner rod, of which one end is arranged coaxially inside a first end of the spire, or by an outer rod, of which one end is arranged coaxially around the first end of the spire, while the second end of the spire is connected to the source of current supplying either the rod or the tube in order to close the circulation circuit of the current.

In the same technical field of washing machines as U.S. Pat. No. 4,697,069, documents DE-U-89 10 145, EP-A-1 111 962 and GB-A-658 711 also propose heating cartridges of which the resistor is a spire of which the opposite ends are connected to a source of current. The same spire structure is present for the heating resistor of the cartridge considered in DE-A-28 56 444, which is specifically designed for the field of plastic injection moulds.

The objective of this invention is to propose a heating cartridge for a thermostatic element, of which the heating resistor is more economical to manufacture and simpler to assemble to the rest of the cartridge.

To this effect, the objective of the invention is a heating cartridge for a thermostatic element, such as defined in claims 1.

One of the ideas at the basis of the invention is to replace the existing structures with a resistant filament in the shape of a spire with a resistant tubular body, arranged both coaxially inside the tube of the cartridge and coaxially around a central rod of this cartridge, being in electrical contact with both this tube and this rod. By providing that the tube and the rod are made of electrically conducting materials, typically of metal, it is possible to connect the tube and the rod respectively to the poles of an external electrical power, and as such to circulate a current through the aforementioned resistant tubular body: in service, this body is heated by the Joule effect and the heat energy is then diffused through the tube, to the heat-expandable material of a thermostatic element. The cost of the heating cartridge according to the invention is low as its primary components, which are the tube, the rod and the tubular heating resistor, are simple to manufacture. In addition, the assembly of these components is economical, in that the corresponding assembly operations, all centred on the common central axis of these components, can be automated.

Advantageous characteristics of the heating cartridge in accordance with the invention, taken separately or according to all technically possible combinations, are specified in dependent claims 2 to 12.

The invention further has for object a thermostatic element, such as defined in claim 13.

The invention shall be better understood when reading the following description, provided solely by way of example and in reference to the drawings wherein:

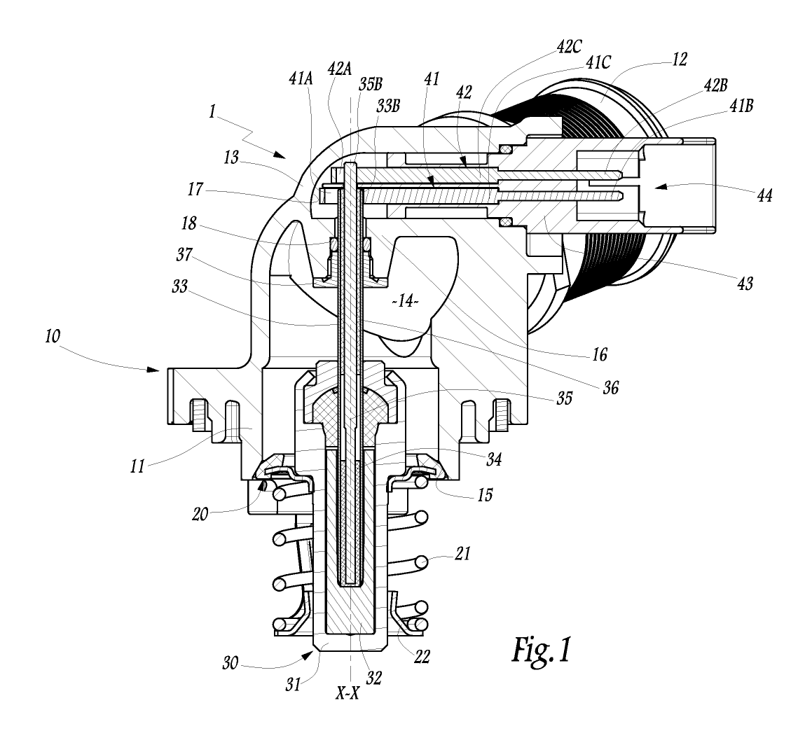

FIG. 1 is a longitudinal cross-section of a valve comprising a thermostatic element in accordance with the invention;

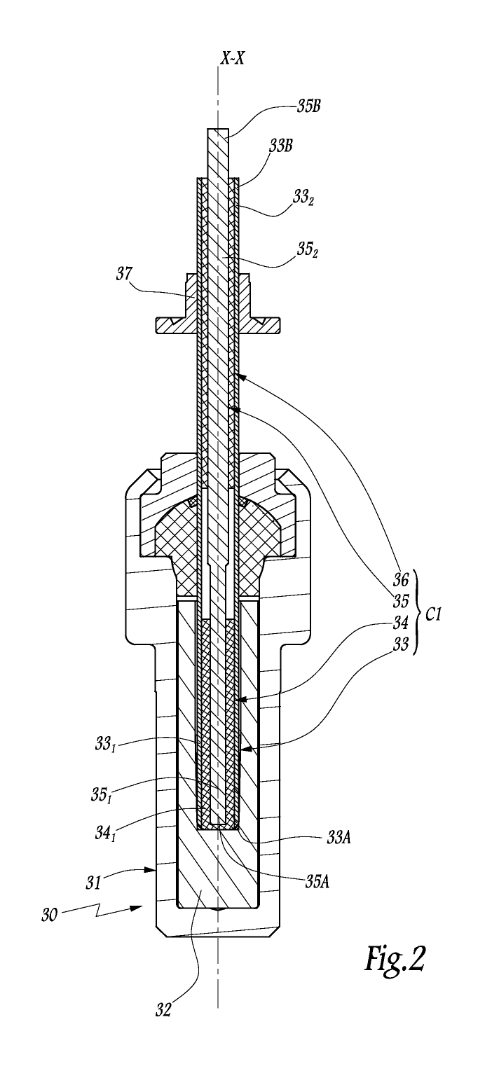

FIG. 2 is a longitudinal cross-section of the thermostatic element, shown alone, of FIG. 1;

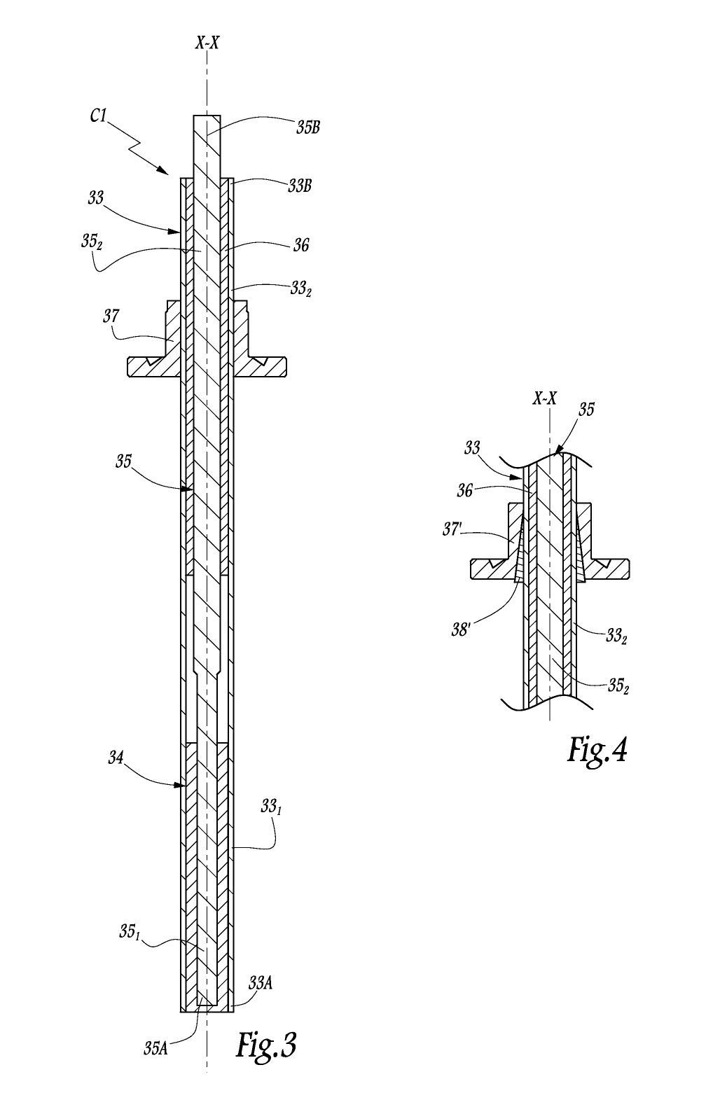

FIG. 3 is a longitudinal cross-section of a heating cartridge, shown alone, belonging to the thermostatic element of FIGS. 1 and 2;

FIG. 4 is a view analogous to FIG. 3, partially showing an alternative embodiment of the heating cartridge, in accordance with the invention;

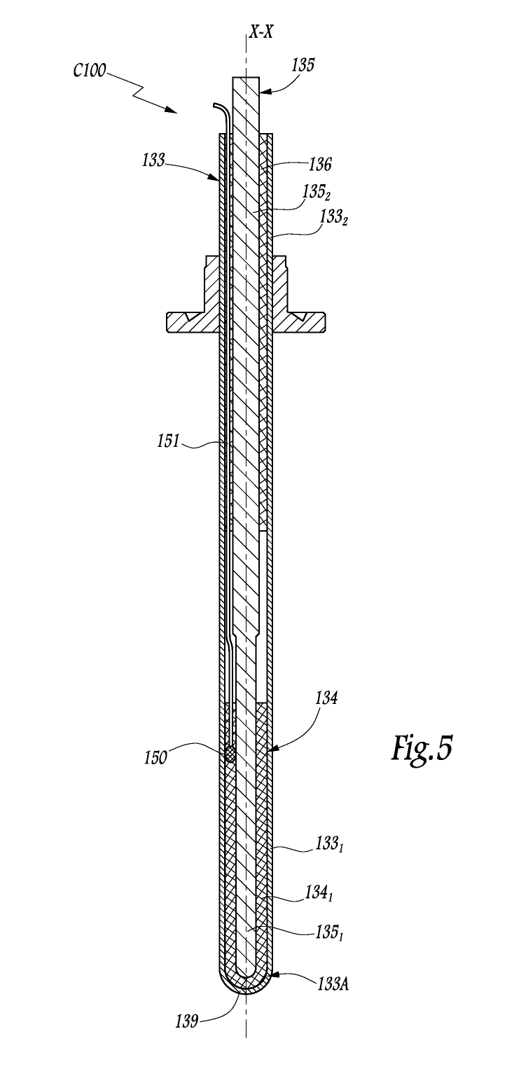

FIG. 5 is a view analogous to FIG. 3, showing another alternative embodiment of a heating cartridge in accordance with the invention; and

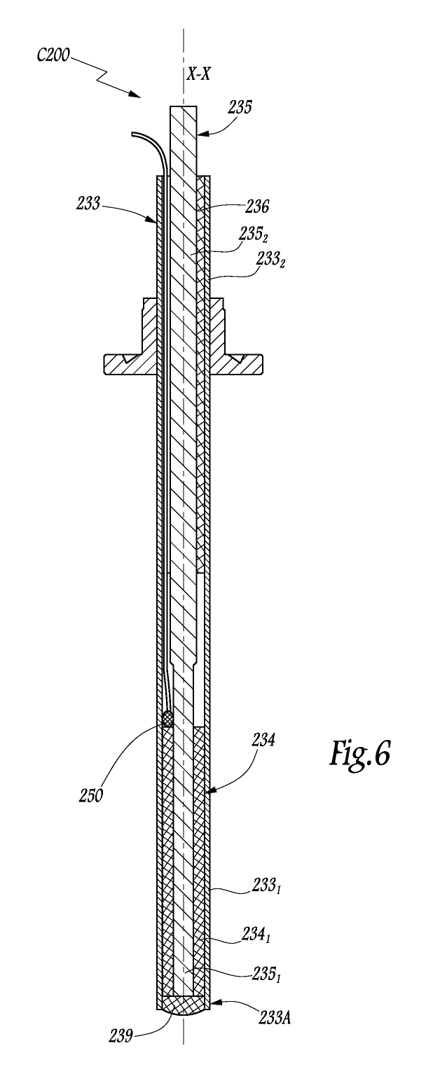

FIG. 6 is a view analogous to FIG. 3, showing another embodiment of a heating cartridge in accordance with the invention.

FIG. 1 shows a thermostatic valve 1 comprising a case 10, made for example of plastic material, wherein is intended to circulate, in a manner regulated by the other components of the valve, a fluid, in particular a coolant when this valve 1 belongs to a cooling circuit for a heat engine.

The case 10 comprises a main tubular body 11 which extends lengthwise in a centred manner around an axis X-X belonging to the section plane of FIG. 1. The case 10 further comprises a tubing 12 which opens transversally into one of the longitudinal ends of the body 11, with this body and this tubing being connected by an elbow-shaped region 13 of the case 10. In service, the aforementioned fluid flows through the body 11 and the tubing 12, by circulating in particular in an internal cavity 14 of the case 10, which is delimited in the elbow-shaped region 13. This flow of fluid is regulated, here on the end of the body 11 opposite the tubing 12, by a closing flap 20 centred on the axis X-X and which can be displaced in translation according to this axis: when this flap is pressed in a sealed manner against a seat 15 delimited by the aforementioned end of the body 11, as shown in FIG. 1, the flow of the fluid is interrupted, while, when the flap 20 is separated from the seat 15, the fluid can freely circulate around the flap and as such enter into or exit from the body 11.

In order to control the displacement of the flap 20, the valve 1 comprises a thermostatic element 30 comprising, as can be seen easily in FIG. 2 and in a manner that is well known in the field, on the one hand, a cup 31, which contains a heat-expandable material 32 and around which the flap 20 is made fixedly integral, for example by press-fitting, and on the other hand, a tube 33 forming a piston, which is in part plunged into the cup 31 and which can be displaced in translation according to its central longitudinal axis under the action of the dilatation of the heat-expandable material contained in this cup. The thermostatic element 30 is arranged across from the case 10 in such a way that, on the one hand, its tube forming a piston 33 is centred on the axis X-X and, on the other hand, this tube is fixedly connected to the case 10, here on the elbow-shaped region 13 of this case, as specified in more detail in what follows. As such, in service, the tube 33 is fixed in relation to case 10, while the cup 31 and the flap 20 that it carries can be displaced according to the axis X-X in relation to the case, under the effect of the heat-expandable material when the latter expands, or, when this material contracts, under the opposite effect of a return spring 21 positioned between the flap 20 and a rigid armature 22 integral with the case 10 through arrangements not shown in detail and known per se.

In practice, various embodiments can be considered with regards to the case 10, the flap 20, the spring 21 and the armature 22, without being restrictions of the invention. As such, for example, rather than the seat 15 supporting the flap 20 being delimited directly par the case 10, this seat can be delimited by a dedicated portion of the armature 22.

The thermostatic element 30 is provided with an electrical heating resistor 34 which, as shown in more detail in FIG. 3, is arranged inside the tube 33, by being located in the longitudinal end portion 33₁ of this tube, which plunges into the cup 31, so that the heating resistor 34 can heat the heat-expandable material 32 contained in the cup. For this purpose, the tube 33 is made, at least in regards to its end portion 33₁, of a heat conducting material, typically of metal.

As can be seen easily in FIG. 3, the heating resistor 34 has substantially the form of a tubular body 34₁, which is centred on the axis X-X and of which the transversal section has an additional exterior profile, and is even adjusted on the interior profile of the transversal section of the end portion 33₁ of the tube 33. In other words, the tubular body 34₁ of the resistor 34 is arranged coaxially inside the end portion 33₁ of the tube 33, by forming exteriorly a contact interface with the inner surface of this end portion 33₁.

In addition, a rod 35 extends lengthwise inside the tubular body 34₁, by being centred on the axis X-X and by extending over the entire axial dimension of the tubular body 34₁, as well as by extending beyond this tubular body, in such a way as to run inside the tube 33, over substantially the entire axial dimension of this tube. As such, the rod 35 includes a longitudinal end portion 35₁, which is arranged coaxially inside the body 34₁ of the resistor 34 and of which the transversal section has an additional exterior profile, and is even adjusted on the interior profile of the transversal section of this tubular body. In other words, the tubular body 34₁ of the resistor 34 is radially positioned between the end portions 33₁ and 35₁ of the tube 33 and of the rod 35, by forming interfaces, of cylindrical contact with each of these end portions.

The rod 35 further includes a longitudinal end portion 35₂, opposed axially to its end portion 35₁, which extends coaxially inside of the tube 33, more precisely on a longitudinal end portion 33₂ of this tube, opposed axially to its end portion 33₁. Between the end portions 33₂ and 35₂ of the tube 33 and of the rod 35 is radially positioned a tubular bushing 36, which is centred on the axis X-X and of which the transversal section has exterior and interior profiles which are respectively complementary, and even adjusted on the exterior and interior profiles of these end portions 33₂ and 35₂.

Contrary to the bushing 36 which is made from an electrically insulating material, for example made exclusively from a thermoplastic polymer, the heating resistor 34 is constituted of a mixture between a thermo-setting polymer, such as an epoxy glue, at least one conducting powder, such as carbon black, and, possibly, other additives. In this way, the resistor 34 allows the circulation of an electric current through it, while still having an electrical resistivity which, by the Joule effect, induced its heating in service.

In the embodiment considered in the FIGS. 1 to 3, the thermo-setting nature of the polymer belonging to the material constituting the resistor 34 is also used to facilitate the manufacturing of the heating cartridge C1 shown in FIG. 3, which includes the tube 33, the resistor 34, the rod 35 and the bushing 36. Indeed, before polymerisation of this thermo-setting polymer, the mixture constituting the material of the resistor 34 is viscous, while, after polymerisation, this mixture solidifies and adheres both to the tube 33 and to the rod 35, providing links that are mechanical, electrical and thermal.

In order to apply an electric voltage between the inner and outer surfaces of the tubular body 34₁ of the heating resistor 34, the tube 33 and the rod 35 are used, by applying on this tube and on this rod a difference in electrical potential, provided the tube and the rod are connected respectively to the positive and negative poles of an external current source not shown in the figures. In practice, it is understood that the tube 33 and the rod 35 must be made of electrically conducting materials, typically of metal.

For the purposes of fixing the tube 33 to the case 10 of the valve 1, the end portion 33₂ of the tube is exteriorly provided with a collar 37 rigidly integral with the outer surface of the tube. To do this, several possibilities of fastening can be considered: in FIG. 3, the collar 37 is crimped around the end portion 33₂ of the tube 33. As an alternative, in FIG. 4, a collar 37′, functionally similar to the collar 37, is fixed to the end portion 33₂ of the tube 33 by a self-locking cone 38′ which is added radially between the collar 37′ and the tube 33, by becoming wedged against an additional tapered surface delimited by the collar 37′.

Before describing the operation of the valve 1 in more detail, in particular its heating cartridge C1, the manufacturing of this valve is presented hereinafter.

The heating cartridge C1 can firstly be assembled independently of the other components of the valve 1. To do this, as mentioned hereinabove, the viscous mixture of thermo-setting polymer, of conductive powder or powders and of any other additives is set in place between the end portions 33₁ and 35₁ of the tube 33 and of the rod 35. This operation takes advantage of the fact that the free end 33A of the end portion 33₁ of the tube 33 is axially open, as can be seen easily in FIG. 3: in these conditions, the aforementioned viscous mixture coats the entire end portion 35₁ of the rod 35, in particular by covering its corresponding free end 35A, while still closing in a sealed manner the end 33A of the tube 33. Then, after having set in place the insulation bushing 36 between the end portions 33₂ and 35₂ of the tube 33 and of the rod 35, the assembling obtained is placed in an oven until polymerisation of the mixture. The collar 37 is then added and made integral around the tube 33.

The heating cartridge C1 obtained as such can then be assembled to the other components of the valve 1.

In particular, the end portion 33₁ of the tube 33 is assembled to the cup 31, by being plunged in a sealed manner into the heat-expandable material 32 contained in this cup: the portion of the heating resistor 34, closing the open end 33A of the tube 33, seals the inside of this tube with regards to the heat-expandable material 32. Moreover, in a manner known per se, an annular seal, arranged at the open end of the cup 21, seals the outside of the tube 33 with regards to the heat-expandable material.

In addition, the end portion 33₂ of the tube 33 is introduced axially into the body 11 of the case 10, by being engaged therein via the end of this body opposite the elbow-shaped region 13. As shown in FIG. 1, the end portion 33₂ of the tube 33 is axially passed through a wall 16 of the case 10, which closes the cavity 14 according to the direction of the axis X-X, until empty space 17 delimited in the thickness of the elbow-shaped region 13 of the case 10 is reached. This operation of assembling the tube 33 to the case 10 leads to axially pressing the collar 37 against the wall 16, with axial positioning of a seal 18 surrounding the tube 33. This tube 33 is fixedly connected to the case 10, by the maintaining in axial support its collar 37 against the wall 16 under the action of the spring 21 after assembly of the latter to the case thanks to the armature 22.

The seal 18 can, in an alternative not shown, be replaced with other functionally similar means of sealing, such as a glue or a sealing paste.

Inside the aforementioned empty space 17, the end portions 33₂ and 35₂ of the tube 33 and of the rod 35 are respectively connected electrically to two extended terminal lugs 41 and 42 which extend lengthwise to the exterior of the case 10 in order to be connected to an external current source, not shown in the figures. In the example embodiment considered in FIG. 1, the terminal lugs 41 and 42 include respective longitudinal ends 41A and 42A which are respectively connected to the free end 33B of the end portion 33₂ of the tube 33 and to the free end 35B of the end portion 35₂ of the rod 35: in other words, the aforementioned free ends 33B and 35B of the tube 33 and of the rod 35 constitute two connection terminals for the heating cartridge C1, having respectively tubular and cylindrical shapes, both centred on the axis X-X, these cylindrical and tubular connection terminals being provided to be connected to the aforementioned external current source, respectively by the intermediary of the terminal lugs 41 and 42. For the purposes of mechanical strength and sealing, the respective current portions 41C and 42C of the terminal lugs 41 and 42 are coated, typically by overmoulding, by an insulating material which as such forms a support base 43 which is added in a sealed manner to the space 17. This base 43 delimits a housing 44 for connecting the aforementioned external current source, wherein extend the respective ends 41B and 42B of the terminal lugs 41 and 42, opposite their end 41A and 42A.

In practice, diverse embodiments can be considered with regards to the electrical connection between the aforementioned external current source and the terminals which constitute the ends 33B and 35B of the end portions 33₂ and 35₂ of the tube 33 and of the rod 35, without being restrictive of the invention.

An example of the operation of the valve 1 is as follows. After having connected an external current source in the housing 44, the application of an electric voltage on the terminal lugs 41 and 42 circulates a current through successively the tube 33, the heating resistor 34 and the rod 35. As explained hereinabove, due to its resistivity, the resistor 34, substantially its tubular body 34₁, is heated by the Joule effect: the heat energy created as such is diffused through the end portion 33₁ of the tube 33 and reaches the heat-expandable material 32. This rise in temperature of the heat-expandable material 32 generates a dilatation of the latter, with for consequence a translational displacement according to the axis X-X between the tube 33 and the cup 31: with the tube 33 being fixed, the cup 31 is translated, by increasing the deployed extent of the tube 33 in relation to it.

It is understood that it is necessary to control the electrical power delivered to the heating resistor 34 in order to correctly control the amplitude of the relative displacement between the cup 31 and the tube 33, as well as in order to limit the surface temperature of the tube 33 so that the latter does not deteriorate the parts in contact with it. In practice, this control of the electrical power can be carried out in two possible ways.

A first way consists in regulating the electrical power via a calculator, by the variation in the voltage of a continuous signal or by the variation of the opening cyclic ratio (OCR) of a sliced signal, according to a suitable algorithm taking into account the temperature of the tube 33 or its position in relation to the cup 31 or a parameter that depends on one or the other of the aforementioned characteristics, for example the temperature of the fluid circulating in the cavity 14. This method of regulation is typically applied in the case where the resistivity of the heating resistor 34 is practically constant according to its temperature.

The second way of controlling the electrical power delivered to the heating cartridge C1 consists in self-regulating in temperature this heating cartridge, in the case where the resistor 34 is designed in the form of a resistor with a positive temperature coefficient. To do this, according to the nature and/or the proportion of the conductive powder or powders of which is loaded the material constituting the heating resistor 34, this material advantageously has an electrical resistivity that increases with its temperature, in particular in the operating temperature range of the heating cartridge C1. In this way, for a constant supply voltage, the power delivered to the resistor 34 decreases with the temperature since the resistivity of this resistor increases with the temperature. As such, by supplying the heating cartridge C1 with a constant voltage, its temperature increases until a balance is reached between the electrical power, which decreases with the temperature, and the power dissipated to the ambient surroundings, i.e. in the fluid circulating in the cavity 14 in the case of the valve 1, which increases with the temperature.

This possibility of having a stabilised self-regulated temperature, linked to the nature of the mixture constituting the material of the heating resistor 34, makes it possible to simplify the algorithm for regulating the supply of the heating cartridge C1, as well as increasing the reliability of the thermostatic element 30.

FIG. 5 shows an alternative embodiment of the heating cartridge C1, referenced as C100. This heating cartridge C100 comprises a tube 133, a heating resistor 134, a rod 135 and an insulation bushing 136, all centred on an axis X-X and functionally similar, respectively, to the tube 33, to the heating resistor 34, to the rod 35 and to the bushing 36 of the heating cartridge C1.

The tube 133 is distinguished from the tube 33 by the fact that the free end 133A of its end portion 133₁, wherein is arranged their heating resistor 134, is not axially open as the end 33A, but is closed by a bottom 139 formed integrally with the rest of the tube 133. In other words, this tube 133 has the shape of a bucket. This shape of a bucket guarantees a good seal on the bottom 139 of the tube 133, in particular in that this bottom 139 covers the corresponding end of the tubular body 134₁ of the heating resistor 134, radially positioned between the end portion 133₁ of the tube 133 and an end portion 135₁ of the rod 135, functionally similar to the end portion 35₁ of the rod 35. On the other hand, in comparison with the tube 33 obtained at a lesser cost by drawing, the aforementioned bucket shape of the tube 133 requires more elaborate manufacturing operations, such as stamping for the example shown in FIG. 5, or, in terms of an alternative not shown, the welding to the rest of the tube 133 of an added part intended to form the bottom 139.

Moreover, the aforementioned bucket shape is entirely compatible with the setting in place in viscous state of the mixture with a thermo-setting polymer base which, after polymerisation, constitutes the heating resistor 134.

The heating cartridge C100 is further distinguished from the heating cartridge C1 by the additional presence, optionally, of a built-in temperature sensor 150. More precisely, as can be seen easily in FIG. 5, this sensor 150, for example of the thermocouple type or of the platinum filament type, is advantageously embedded in the heating resistor 144, by being set into place in this way before polymerisation of the mixture with a thermo-setting polymer base constituting this resistor. The sensor 150 is as such arranged radially between the end portions 133₁ and 135₁ of the tube 33 of the rod 35, in the thickness of the tubular body 134₁ of the heating resistor 134. The output signal of this sensor 150 is advantageously transmitted to the outside of the heating cartridge C100 by at least one element for transmitting 151, typically one or several wires, which run according to the direction of the axis X-X, radially between the rod 35 and the tube 33. In particular, this element for transmitting 151 runs between the end portions 133₂ and 135₂ of the tube 133 and of the rod 135, which are functionally similar, respectively, to the end portions 33₂ and 35₂ of the tube 33 and of the rod 35, and between which the insulation bushing 136 is radially positioned. Of course, the element for transmitting 151 passes axially through on either side the wall constituting this bushing 136, until exiting outside of the tube 133, as shown in FIG. 5.

The temperature sensor 150 can advantageously be used to provide temperature measurements, taken into account by the algorithm, mentioned hereinabove, in order to regulate the electrical power delivered to the heating cartridge C100.

FIG. 6 shows an alternative embodiment of the heating cartridges C1 and C100, referenced as C200. This heating cartridge C200 comprises a tube 233, a heating resistor 234, a rod 235, an insulation bushing 236 and a temperature sensor 250, which are functionally similar, respectively, to the tube 33 or 133, to the heating resistor 34 or 134, to the rod 35 or 135, to the bushing 36 or 136, and to the temperature sensor 150 of the heating cartridge C1 or C100.

The heating resistor 234 is distinguished from the heating resistors 34 and 134 by the nature of the polymer forming the base of the mixture that comprises them: the heating cartridge 234 is made of a material constituted of a thermoplastic polymer which, in the same way as for the thermo-setting polymer of the heating resistors 34 and 134, is loaded with at least one conducting powder and possibly other additives. The thermoplastic polymer base of the material constituting the heating resistor 234 is such that, after forming this material, the heating resistor 234 is made available in the form of a rigid or semi-rigid tubular body 234₁, able to be added via mechanical assembly to the rest of the heating cartridge C200. In particular, this tubular body 234₁ is fitted between end portions 233₁ and 235₂ of the tube 233 and of the rod 235. In practice, this press fitting can be carried out first around the end portion 235₂ of the rod 235, with the end portion 233₁ of the tube 233 then being press fitted around the tubular body 234₁ of the heating resistor 234, or inversely. Moreover, each of these two fittings can be carried out either in a tightening manner, by taking advantage of a capacity of elastic deformation, radial in particular, of the body 234₁ of the heating resistor 234, or with radial positioning of a conductive paste.

The free end 233A of the end portion 233₁ of the tube 233 is closed in a sealed manner by a bottom 239 forming an electrically insulating cap. Diverse possibilities of carrying out this bottom forming a cap 239 can be considered: an insulating glue, such as an epoxy glue, can be applied inside the end 233A of the tube 233, this glue providing, after polymerisation, both a mechanical connection with the tube as well as an electrical insulation between the tube and the respective corresponding ends of the rod 235 and of the tubular body 234₁ of the heating resistor 234, covered by the glue. As an alternative, the bottom forming a cap 239 is a part made of insulating material, added in a sealed manner, for example by crimping, in the end 233A of the tube 233.

One of the interests in using a thermoplastic polymeric base for the material constituting the heating resistor 234 is linked to the possibility of, before assembling the tubular body 234₁ of this heating resistor to the rest of the heating cartridge C200, covering this body with an electrically conductive thin layer, typically with a metal layer, in particular made of silver, i.e., more generally, with a conductive layer of which the conductivity is greater than or equal to that of the tube 233 and of the rod 235. In this way, the electrical contact between, on the one hand, the tube 233 and the rod 235 and, on the other hand, the heating cartridge 234 covered as such is improved, by being particularly reliable.

Inversely, assembling mechanically the heating resistor 234 to the rest of the heating cartridge C200 required ad hoc assembly operations and requires the provision of the bottom forming a cap 239.

Note that this form of embodiment of the heating resistor 234 makes it possible, as for the forms of embodiment of the resistors 34 and 134, to incorporate the temperature sensor 250, which is then arranged in contact with the tubular body 234₁, as well as to obtain, according to the nature and the proportion of the conductive powder or powders mixed with the thermoplastic polymer, that the electrical resistivity of the mixture obtained be constant or increasing according to the temperature, at least within a certain temperature range corresponding to the operating range of the heating cartridge C200.

In terms of an alternative not shown, the tube 233 of the heating cartridge C200 can have, at its end 233A, the same structure as that of the tube 133 of the heating cartridge C100.

According to another alternative not shown of the heating cartridge C200, the material constituting the heating resistor 234 is not a mixture with a polymer base, but is a conductive ceramic having a certain resistivity. This is in particular the case with polycrystalline doped ceramic materials, with a barium titanate base. Such a ceramic can in particular be chosen in order to have characteristics of a resistor with a positive temperature coefficient. In practice, with regards to the rigidity of such a resistant material with a ceramic base, the heating resistor 234 which is constituted of it is assembled and connected to the rest of the heating cartridge C200 in a way similar to what has just been described with regards to FIG. 6.

Finally, in addition to the preceding, various arrangements and alternatives to the heating cartridges C1, C100 and C200, as well as to the thermostatic valve 1 described until now can moreover be considered. In particular, note that, in the examples of embodiments considered in the figures, the tube 33, 133 or 233 of the heating cartridge C1, C100 or C200, wherein is arranged the heating resistor 34, 134 or 234, constitutes the piston of the thermostatic element 30: however, for other thermostatic valve construction geometries, this tube of the heating cartridge and the piston of the thermostatic element, of which the heat-expandable material is heated by the heating resistor belonging to the cartridge, can consist of two separate parts. In this case, generally, the tube of the heating cartridge extends through the bottom of the cup of the thermostatic element, opposite the piston of this element, the cup then being fixed in relation to the case, while the piston carries a shutter in order to control the opening and the closing of the latter with regards to the case.

1.-13. (canceled)

14. A heating cartridge for a thermostatic element, comprising:
a tube, which is both thermally and electrically conductive and of which a first end portion is adapted to be embedded within a heat-expandable material of a thermostatic element,
a heating resistor which is arranged inside the first end portion of the tube,
a rod, which is electrically conductive and which extends at least partially into the tube in a substantially coaxial manner,
wherein the heating resistor comprises a tubular body, which is constituted of an electrically resistant material and which is radially positioned between a first end portion of the rod and the first end portion of the tube, by forming a cylindrical interface for electrical contact between the rod and the inner surface of the tubular body as well as a cylindrical interface for electrical contact between the tube and the outer surface of the tubular body,
and wherein the tube and the rod include respectively, opposite their first end portion, second end portions which are respectively adapted to be connected to the poles of an external current source in such a way as to apply an electrical voltage between the inner and outer surfaces of the tubular body of the heating resistor.

15. The heating cartridge according to claim 14, wherein the material constituting the tubular body of the heating resistor is a polymer loaded with at least one electrically conductive powder.

16. The heating cartridge according to claim 15, wherein the polymer is a thermo-setting material adapted, before polymerisation, to be set in place in viscous form between the first end portion of the tube and the first end portion of the rod, by adhering to these first end portions.

17. The heating cartridge according to claim 15, wherein the polymer is a thermoplastic adapted to, after put into form, render the tubular body of the heating resistor able to be added via mechanical assembly to the rest of the heating cartridge.

18. The heating cartridge according to claim 17, wherein the tubular body of the heating resistor is fitted between the first end portion of the tube and the first end portion of the rod, in a tightening manner.

19. The heating cartridge according to claim 17, wherein the tubular body of the heating resistor is fitted between the first end portion of the tube and the first end portion of the rod, with radial positioning of electrically conductive paste.

20. The heating cartridge according to claim 17, wherein the tubular body of the heating resistor is interiorly lined with an electrically conductive layer, of which the conductivity is greater than or equal to that of the tube and of the rod, and which, after assembly of this tubular body to the rest of the heating cartridge, is in contact with the first end portion of the tube.

21. The heating cartridge according to claim 17, wherein the tubular body of the heating resistor is exteriorly lined with an electrically conductive layer, of which the conductivity is greater than or equal to that of the tube and of the rod, and which, after assembly of this tubular body to the rest of the heating cartridge, is in contact with the first end portion of the rod.

22. The heating cartridge according to claim 14, wherein the material constituting the tubular body of the heating resistor is a doped ceramic material.

23. The heating cartridge according to claim 22, wherein the doped ceramic material is with a barium titanate base.

24. The heating cartridge according to claim 22, wherein the tubular body of the heating resistor is fitted between the first end portion of the tube and the first end portion of the rod, in a tightening manner.

25. The heating cartridge according to claim 22, wherein the tubular body of the heating resistor is fitted between the first end portion of the tube and the first end portion of the rod, with radial positioning of electrically conductive paste.

26. The heating cartridge according to claim 22, wherein the tubular body of the heating resistor is interiorly lined with an electrically conductive layer, of which the conductivity is greater than or equal to that of the tube and of the rod, and which, after assembly of this tubular body to the rest of the heating cartridge, is in contact with the first end portion of the tube.

27. The heating cartridge according to claim 22, wherein the tubular body of the heating resistor is exteriorly lined with an electrically conductive layer, of which the conductivity is greater than or equal to that of the tube and of the rod, and which, after assembly of this tubular body to the rest of the heating cartridge, is in contact with the first end portion of the rod.

28. The heating cartridge according to claim 14, wherein the material constituting the tubular body of the heating resistor has, in service, a resistivity that is substantially constant according to its temperature.

29. The heating cartridge according to claim 14, wherein the material constituting the tubular body of the heating resistor has, in service, a resistivity which increases with its temperature.

30. The heating cartridge according to claim 14, wherein the tube is, at the free end of the first end portion of the tube, axially open on the heating resistor.

31. The heating cartridge according to claim 14, wherein, at the free end of the first end portion of the tube, the tube is closed by a bottom, which covers an axial end of the heating resistor and which is integrally formed with the rest of the tube.

32. The heating cartridge according to claim 14, wherein, at the free end of the first end portion of the tube, the tube is closed by a bottom, which covers an axial end of the heating resistor and which is added in a sealed manner in this free end of the tube.

33. The heating cartridge according to claim 14, wherein the heating cartridge further comprises a temperature sensor, which is incorporated between the tube and the rod by being arranged in the thickness of the tubular body of the heating resistor, and of which the output signal is transmitted to the outside of the heating cartridge by an element for transmitting which runs between the second end portion of the tube and the second end portion of the rod.

34. The heating cartridge according to claim 14, wherein the heating cartridge further comprises a temperature sensor, which is incorporated between the tube and the rod by being arranged in contact with the tubular body of the heating resistor, and of which the output signal is transmitted to the outside of the heating cartridge by an element for transmitting which runs between the second end portion of the tube and the second end portion of the rod.

35. A thermostatic element, comprising a heating cartridge in accordance with claim 14, and a cup containing a heat-expandable material wherein is embedded the tube of the heating cartridge.
